(19) United States
(12) Patent Application Publication
(10) Pub. No.: US 2016/0227089 A1
(43) Pub. Date: Aug. 4, 2016

(54) CAMERA UNIT AND ELECTRONIC DEVICE

(71) Applicant: LARGAN PRECISION CO., LTD., Taichung City (TW)

(72) Inventors: En-Ping Lin, Taichung City (TW); Wei-Yu Chen, Taichung City (TW)

(21) Appl. No.: 14/676,570

(22) Filed: Apr. 1, 2015

Related U.S. Application Data
(60) Provisional application No. 62/111,331, filed on Feb. 3, 2015.

(51) Int. Cl. H04N 5/225; H04N 5/232; G02B 13/02

(52) U.S. Cl. CPC H04N 5/2258; G02B 13/02; H04N 5/23245; H04N 5/2254

(57) ABSTRACT

A camera unit includes a wide-angle image capturing module, a standard image capturing module and a telephoto image capturing module. The wide-angle image capturing module includes a wide-angle lens assembly and a wide-angle image sensor. The wide-angle lens assembly, in order from an object side to an image side, includes a first lens element thereof closest to the object side and a last lens element thereof closest to the image-side. The standard lens assembly, in order from an object side to an image side, includes a first lens element thereof closest to the object side and a last lens element thereof closest to the image-side. The telephoto lens assembly, in order from an object side to an image side, includes a first lens element thereof closest to the object side and a last lens element thereof closest to the image-side.

### RELATED APPLICATIONS

This application claims priority to U.S. provisional Application 62/111,331, filed Feb. 3, 2015, which is incorporated by reference herein in its entirety.

### BACKGROUND

1. Technical Field

The present disclosure relates to a camera unit and an electronic device, more particularly to a camera unit having a wide-angle image capturing module, a standard image capturing module and a telephoto image capturing module and an electronic device having the camera unit.

2. Description of Related Art

In recent years, the advanced manufacturers not only improve the imaging resolution of miniaturized camera units installed on smart devices but also reduce a total track length of a lens assembly in the miniaturized camera unit in order to install the miniaturized camera units into the thinner smart devices. Therefore, the miniaturized camera unit has played a more prominent role on the smart devices and has more functions for the camera unit when the imaging resolution is improved. The functions include imaging technique of post-focusing adjustment, bokeh effect and automated post image processing. However, the miniaturized camera unit still lacks of the ability of optical zoom.

A conventional camera unit adopts an electro-mechanical part for zoom for performing the optical zoom. However, the electro-mechanical part for zoom consumes more power and needs longer space to accommodate a stabilization unit for avoiding the image distortion caused by shaking Therefore, the size of the camera unit is increased due to the adoption of the electro-mechanical part for zoom so that it is unfavorable for equipping the camera unit on the compact electronic device.

Some manufacturers develop a compact electronic device including a camera unit with two image capturing modules in order to satisfy the requirement of the ability of optical zoom and compact size simultaneously. For example, the camera unit can include a telephoto image capturing module and a wide-angle image capturing module. Nevertheless, compared with the camera unit including the electro-mechanical part for zoom, the camera unit including two image capturing modules is unfavorable for improving image resolution, having sufficient field of view and large zoom magnification.

### SUMMARY

According to one aspect of the present disclosure, a camera unit includes a wide-angle image capturing module, a standard image capturing module and a telephoto image capturing module. The wide-angle image capturing module includes a wide-angle lens assembly and a wide-angle image sensor. The wide-angle lens assembly includes, in order from an object side to an image side thereof, a first lens element thereof closest to the object-side and a last lens element thereof closest to the image-side. Both of the first lens element and the last lens element of the wide-angle lens assembly have refractive power. The wide-angle image sensor is disposed on the image side of the wide-angle lens assembly. The standard image capturing module includes a standard lens assembly and a standard image sensor. The standard lens assembly includes, in order from an object side to an image side thereof, a first lens element thereof closest to the object-side and a last lens element thereof closest to the image-side. Both of the first lens element and the last lens element of the standard lens assembly have refractive power. The standard image sensor is disposed on the image side of the standard lens assembly. The telephoto image capturing module includes a telephoto lens assembly and a telephoto image sensor. The telephoto lens assembly includes, in order from an object side to an image side thereof, a first lens element thereof closest to the object-side and a last lens element thereof closest to the image-side. Both of the first lens element and the last lens element of the telephoto lens assembly having refractive power. The telephoto image sensor is disposed on the image side of the telephoto lens assembly. Each of the lens elements of the wide-angle lens assembly, the standard lens assembly and the telephoto lens assembly with refractive power has an object-side surface and an image-side surface. The wide-angle lens assembly, the standard lens assembly and the telephoto lens assembly are all single focus lens assemblies. When a maximal field of view of the wide-angle lens assembly is FOV(W), a maximal field of view of the standard lens assembly is FOV(M), a maximal field of view of the telephoto lens assembly is FOV(T), the following conditions are satisfied:

FOV(T)<FOV(M)<FOV(W);

15 degrees (deg.)<FOV(T)<50 deg.;

45 deg.<FOV(M)<100 deg.; and

70 deg.<FOV(W)<150 deg.

According to another aspect of the present disclosure, an electronic device includes the aforementioned camera unit. A plurality of raw images are captured from at least two of the wide-angle image capturing module, the standard image capturing module and the telephoto image capturing module of the camera unit, and a final photographed image is produced by post-processing of the raw images.

### BRIEF DESCRIPTION OF THE DRAWINGS

The disclosure can be more fully understood by reading the following detailed description of the embodiments, with reference made to the accompanying drawings as follows:

FIG. 1A is a schematic view of a telephoto image capturing module according to the 1st embodiment of the present disclosure;

FIG. 1B is a schematic view of a standard image capturing module according to the 1st embodiment of the present disclosure;

FIG. 1C is a schematic view of a wide-angle image capturing module according to the 1st embodiment of the present disclosure;

FIG. 2A is a schematic view of a telephoto image capturing module according to the 2nd embodiment of the present disclosure;

FIG. 2B is a schematic view of a standard image capturing module according to the 2nd embodiment of the present disclosure;

FIG. 2C is a schematic view of a wide-angle image capturing module according to the 2nd embodiment of the present disclosure;

FIG. 3 shows a wide-angle image capturing module, a standard image capturing module and a telephoto image capturing module having different field of views according to one embodiment of the present disclosure;

FIG. 4 shows the images captured by the wide-angle image capturing module, the standard image capturing module and the telephoto image capturing module in FIG. 3 according to the embodiment of the present disclosure;

FIG. 5A shows an electronic device according to one embodiment;

FIG. 5B shows an electronic device according to another embodiment; and

FIG. 5C shows an electronic device according to still another embodiment.

### DETAILED DESCRIPTION

A camera unit includes a wide-angle image capturing module, a standard image capturing module and a telephoto image capturing module. The wide-angle image capturing module, the standard image capturing module and the telephoto image capturing module are all for facing towards an object.

The wide-angle image capturing module includes a wide-angle lens assembly and a wide-angle image sensor. The wide-angle lens assembly includes, in order from an object side to an image side thereof, a first lens element thereof closest to the object-side and a last lens element thereof closest to the image-side. The first lens element and the last lens element of the wide-angle lens assembly both have refractive power. In detail, the first lens element of the wide-angle lens assembly is the closest lens element to the object side thereof among all lens elements of the wide-angle lens assembly with refractive power, and the last lens element of the wide-angle lens assembly is the closest lens element to the image side thereof among all lens elements of the wide-angle lens assembly with refractive power (i.e., all lens elements of the wide-angle lens assembly at least includes the first lens element and the last lens element of the wide-angle lens assembly). Each of the lens elements of the wide-angle lens assembly with refractive power has an object-side surface and an image-side surface. The wide-angle image sensor is disposed on the image side of the wide-angle lens assembly. There are at least three and fewer than seven lens elements with refractive power in the wide-angle lens assembly. Preferably, there are at least four and fewer than six lens elements with refractive power in the wide-angle lens assembly.

The standard image capturing module includes a standard lens assembly and a standard image sensor. The standard lens assembly includes, in order from an object side to an image side thereof, a first lens element thereof closest to the object-side and a last lens element thereof closest to the image-side. The first lens element and the last lens element of the standard lens assembly both have refractive power. In detail, the first lens element of the standard lens assembly is the closest lens element to the object side thereof among all lens elements of the standard lens assembly with refractive power, and the last lens element of the standard lens assembly is the closest lens element to the image side thereof among all lens elements of the standard lens assembly with refractive power (i.e., all lens elements of the standard lens assembly at least includes the first lens element and the last lens element of the standard lens assembly). Each of the lens elements of the standard lens assembly with refractive power has an object-side surface and an image-side surface. The standard image sensor is disposed on the image side of the standard lens assembly. There are at least three and fewer than seven lens elements with refractive power in the standard lens assembly. Preferably, there are at least four and fewer than six lens elements with refractive power in the standard lens assembly.

The telephoto image capturing module includes a telephoto lens assembly and a telephoto image sensor. The telephoto lens assembly includes, in order from an object side to an image side thereof, a first lens element thereof closest to the object-side and a last lens element thereof closest to the image-side. The first lens element and the last lens element of the telephoto lens assembly both have refractive power. In detail, the first lens element of the telephoto lens assembly is the closest lens element to the object side thereof among all lens elements of the telephoto lens assembly with refractive power, and the last lens element of the telephoto lens assembly is the closest lens element to the image side thereof among all lens elements of the telephoto lens assembly with refractive power (i.e., all lens elements of the standard lens assembly at least includes the first lens element and the last lens element of the telephoto lens assembly). Each of the lens elements of the telephoto lens assembly with refractive power has an object-side surface and an image-side surface. The telephoto image sensor is disposed on the image side of the telephoto lens assembly. There are at least three and fewer than seven lens elements with refractive power in the telephoto lens assembly. Preferably, there are at least four and fewer than six lens elements with refractive power in the telephoto lens assembly.

According to the camera unit of the present disclosure, all lens elements of the wide-angle lens assembly with refractive power are stationary relative to one another in a paraxial region thereof. All lens elements of the standard lens assembly with refractive power are stationary relative to one another in a paraxial region thereof. All lens elements of the telephoto lens assembly with refractive power are stationary relative to one another in a paraxial region thereof. For example, in some embodiments, an air gap in a paraxial region is located between every two of all lens elements that are adjacent to each other in the wide-angle lens assembly, the standard lens assembly and the telephoto lens assembly, and the air gaps are constant. Therefore, the wide-angle lens assembly, the standard lens assembly and the telephoto lens assembly are all single focus lens assemblies so that it is unnecessary to dispose additional add-on components such as electro-mechanical part for zoom or optical image stabilization unit, thereby it is favorable for keeping the camera unit compact.

When a maximal field of view of the wide-angle lens assembly FOV(W), a maximal field of view of the standard lens assembly FOV(M), a maximal field of view of the telephoto lens assembly FOV(T), the following condition is satisfied: FOV(T)<FOV(M)<FOV(W). Therefore, the wide-angle lens assembly, the standard lens assembly and the telephoto lens assembly with different field of views are favorable for capturing a plurality of images having various magnifications so as to satisfy the requirement of the ability of optical zoom.

When the maximal field of view of the wide-angle lens assembly FOV(W), the maximal field of view of the standard lens assembly FOV(M), the maximal field of view of the telephoto lens assembly FOV(T), the following conditions are satisfied: 15 degrees (deg.)<FOV(T)<50 deg.; 45 deg.<FOV(M)<100 deg.; and 70 deg.<FOV(W)<150 deg. Therefore, it is favorable for providing high zoom ratios and large zoom range so as to improve the ability of optical zoom. Preferably, the following conditions are satisfied: 30 deg.<FOV(T)<45 deg.; 70 deg.<FOV(M)<95 deg.; and 110 deg.<FOV(W)<140 deg. More preferably, the following conditions are satisfied: 20 deg.<FOV(T)<40 deg.; 45 deg.<FOV(M)<70 deg.; and 75 deg.<FOV(W)<100 deg.

When an axial distance between the object-side surface of the first lens element of the wide-angle lens assembly and the wide-angle image sensor is TL(W), an axial distance between the object-side surface of the first lens element of the standard lens assembly and the standard image sensor is TL(M), an axial distance between the object-side surface of the first lens element of the telephoto lens assembly and the telephoto image sensor is TL(T), the following conditions can be satisfied: TL(W)<10 millimeters (mm); TL(M)<10 mm; and TL(T)<10 mm. Therefore, it is favorable for keeping the camera unit compact so as to be equipped in a compact electronic device. Preferably, the following conditions can be satisfied: TL(W)<8 mm; TL(M)<8 mm; and TL(T)<8 mm.

When an axial distance between the image-side surface of the last lens element of the wide-angle lens assembly and the wide-angle image sensor is BL(W), an axial distance between the image-side surface of the last lens element of the standard lens assembly and the standard image sensor is BL(M), an axial distance between the image-side surface of the last lens element of the telephoto lens assembly and the telephoto image sensor is BL(T), the following conditions can be satisfied: BL(W)<2 mm; BL(M)<2 mm; and BL(T)<2 mm. Therefore, it is favorable for keeping the camera unit compact so as to be equipped in the compact electronic device. Preferably, the following conditions can be satisfied: BL(W)<1.5 mm; BL(M)<1.5 mm; and BL(T)<1.5 mm.

When a diagonal length of an effective photosensitive area of the wide-angle image sensor (i.e., two times a maximum image height of the wide-angle lens assembly) is D(W), a diagonal length of an effective photosensitive area of the standard image sensor (two times a maximum image height of the standard lens assembly) is D(M), a diagonal length of an effective photosensitive area of the telephoto image sensor (two times a maximum image height of the telephoto lens assembly) is D(T), the following conditions can be satisfied: D(T)<D(M) and D(W)<D(M). Therefore, it is favorable for improving the image quality of the image captured by the camera unit.

When the maximal field of view of the wide-angle lens assembly FOV(W), the maximal field of view of the telephoto lens assembly FOV(T), the following condition can be satisfied: 2.0<FOV(W)/FOV(T)<5.0. Therefore, it is favorable for properly arranging the field of views of the wide-angle lens assembly and the telephoto lens assembly so as to provide wide-angle characteristic when the camera unit photographs a moving object.

When an f-number of the wide-angle lens assembly is Fno(W), an f-number of the standard lens assembly is Fno(M), an f-number of the telephoto lens assembly is Fno(T), the following conditions can be satisfied: 1.5<Fno(W)<3.0; 1.5<Fno(M)<3.0; and 1.5<Fno(T)<3.0. Therefore, the wide-angle lens assembly, the standard lens assembly and the telephoto lens assembly are all favorable for obtaining a large aperture for receiving sufficient incoming light, thereby increasing the image quality while the camera unit is in a low light condition with a shutter at a high speed.

When the f-number of the standard lens assembly is Fno(M), the following condition can be satisfied: 1.5<Fno(M)<2.4. Therefore, it is favorable for providing sufficient incoming light while the camera unit photographs the imaged object by the standard image capturing module.

According to the camera unit of the present disclosure, at least one of the image-side surfaces of the last lens elements of the wide-angle lens assembly, the standard lens assembly, and the telephoto lens assembly can have a wave-like shape. For example, when the image-side surface of the last lens element is concave in a paraxial region, the image-side surface of the last lens element can have at least one convex shape in an off-axis region. When the image-side surface of the last lens element is convex in a paraxial region, the image-side surface of the last lens element can have at least one concave shape in an off-axis region.

According to the camera unit of the present disclosure, each of the wide-angle image sensor, the standard image sensor and the telephoto image sensor has a pixel size being smaller than 2.0 micrometers (μm). Therefore, it is favorable for enhancing the image resolution and the image quality of the image captured by the camera unit.

When a focal length of the wide-angle lens assembly is f(W), a focal length of the telephoto lens assembly is f(T), the following condition can be satisfied: 2.0<f(T)/f(W)<5.0. Therefore, it is favorable for obtaining a balance between the telecentric and wide-angle characteristics.

When the axial distance between the object-side surface of the first lens element of the wide-angle lens assembly and the wide-angle image sensor is TL(W), the axial distance between the object-side surface of the first lens element of the telephoto lens assembly and the telephoto image sensor is TL(T), the following condition can be satisfied: TL(W)<TL(T). Therefore, it is favorable for obtaining a balance between the telecentric and wide-angle characteristics.

When the maximal field of view of the wide-angle lens assembly FOV(W), the maximal field of view of the standard lens assembly FOV(M), the maximal field of view of the telephoto lens assembly FOV(T), the following conditions are satisfied: 15 degrees<FOV(M)−FOV(T)<45 degrees, and 20 degrees<FOV(W)−FOV(M)<60 degrees. Therefore, it is favorable for allowing the field of view of the standard lens assembly to properly cover the difference between that of the wide-angle lens assembly and that of the telephoto lens assembly; thereby the camera unit is for capturing different kinds of imaged objects all with good image qualities.

According to the camera unit of the present disclosure, each lens assembly can have an aperture stop configured as a front stop or a middle stop. A front stop disposed between an imaged object and a lens element being the closest one to the imaged object can provide a longer distance between an exit pupil of the lens assembly and the image surface, and thereby improves the image-sensing efficiency of an image sensor (for example, CCD or CMOS). A middle stop disposed between the lens element being the closest one to the imaged object and the image surface is favorable for enlarging the field of view of the camera unit and thereby provides a wider field of view for the same.

According to the camera unit of the present disclosure, all lens elements thereof can be made of glass or plastic material. When the lens elements are made of glass material, the distribution of the refractive power of the lens assembly may be more flexible to design. When the lens elements are made of plastic material, the manufacturing cost can be effectively reduced. Furthermore, surfaces of each lens element can be arranged to be aspheric, since the aspheric surface of the lens element is easy to form a shape other than spherical surface so as to have more controllable variables for eliminating the aberration thereof, and to further decrease the required number of the lens elements. Therefore, the total track length of the lens assembly can also be reduced.

According to the camera unit of the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the camera unit of the present disclosure, an image surface of the lens assembly, based on the corresponding image sensor, can be flat or curved, especially a curved surface being concave facing towards the object side of the lens assembly.

According to the camera unit of the present disclosure, each lens assembly can include at least one stop, such as an aperture stop, a glare stop or a field stop. Said glare stop or said field stop is set for eliminating the stray light and thereby improving the image quality thereof.

According to the present disclosure, an image capturing unit is provided. The image capturing unit includes the camera unit according to the aforementioned camera unit of the present disclosure, and an image sensor, wherein the image sensor is disposed on the image side of the aforementioned camera unit, that is, the image sensor can be disposed on or near an image surface of the aforementioned camera unit. In some embodiments, the image capturing unit can further include a barrel member, a holding member or a combination thereof.

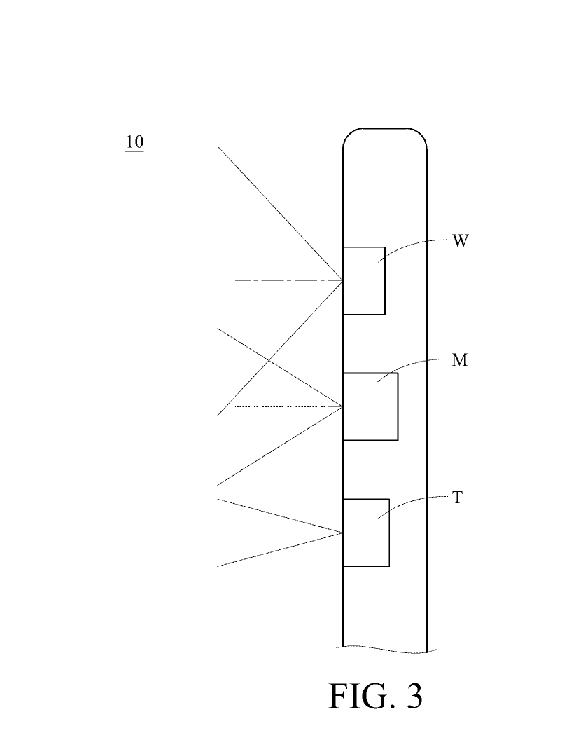

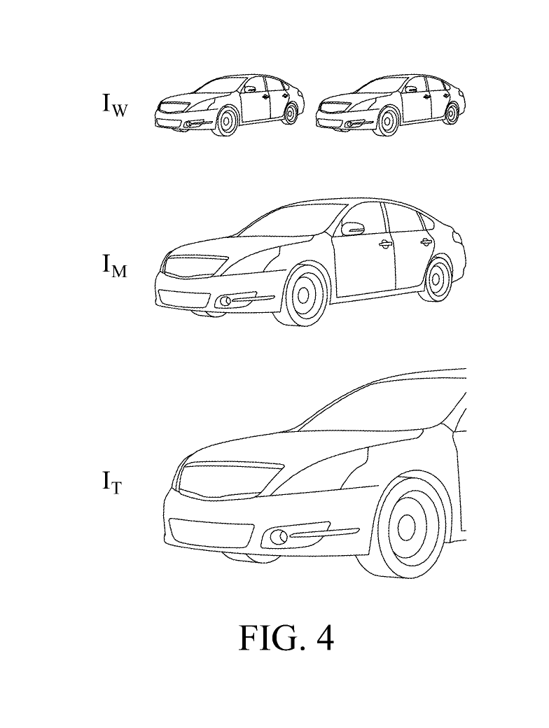

FIG. 3 shows a wide-angle image capturing module, a standard image capturing module and a telephoto image capturing module having different field of views according to one embodiment of the present disclosure. FIG. 4 shows the images captured by the wide-angle image capturing module, the standard image capturing module and the telephoto image capturing module in FIG. 3 according to the embodiment of the present disclosure. As shown in FIG. 3, a camera unit 10 includes a wide-angle image capturing module W, a standard image capturing module M and a telephoto image capturing module T. Each of the wide-angle image capturing module W, the standard image capturing module M and the telephoto image capturing module T can further include an independent barrel, a holding member, an auto-focusing lens actuator, an optical image stabilization unit or a combination thereof.

As shown in FIG. 4, the wide-angle image capturing module W has a field of view being larger than that of the standard image capturing module M and that of the telephoto image capturing module T. The standard image capturing module M has a field of view being smaller than that of the wide-angle image capturing module W but larger than that of the telephoto image capturing module T. The telephoto image capturing module T has a field of view being smaller than that of the standard image capturing module M and that of the telephoto image capturing module T. When the camera unit 10 photographs an imaged object (for example, a plurality of moving cars in FIG. 4), the wide-angle image capturing module W takes a long shot (also referred to as a full shot or a wide shot) to capture an image I_{W} with a wider view of the imaged object, the standard image capturing module M takes a medium shot to capture an image I_{M} with a smaller view of the imaged object than the image I_{W} (for example, one of the moving cars in FIG. 4), and the telephoto image capturing module T takes a close-up shot to capture an image I_{T} with the smallest view of the imaged object (for example, a front portion of the one of the moving cars in FIG. 4). Therefore, it is favorable for capturing the images with the foregoing image capturing modules W, M and T having different field of views so as to satisfy the requirement of the ability of optical zoom.

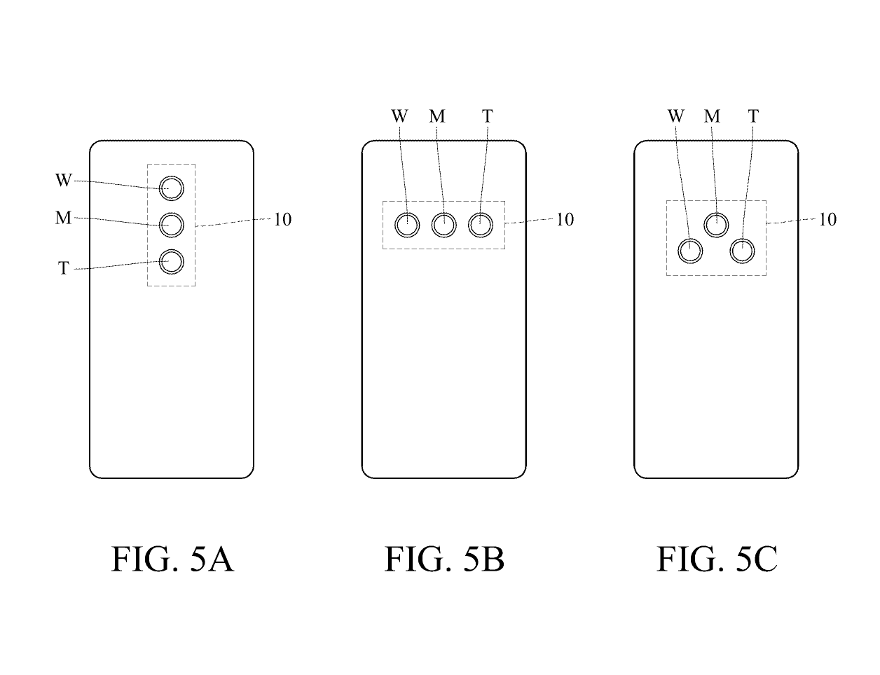

In FIG. 5A, FIG. 5B and FIG. 5C, the camera unit 10 may be installed in, but not limited to, an electronic device, including a smart phone, a tablet personal computer or a wearable device. The three figures of different kinds of electronic device are only exemplary for showing the camera unit 10 of present disclosure installing in an electronic device and is not limited thereto. In some embodiments, the electronic device can further include, but not limited to, a display unit, a control unit, a storage unit, a random access memory unit (RAM), a read only memory unit (ROM) or a combination thereof. Furthermore, the wide-angle image capturing module W, the standard image capturing module M and the telephoto image capturing module T of the camera unit 10 can be disposed in a linear or triangular arrangement. As shown in 5A, FIG. 5B and FIG. 5C, the wide-angle image capturing module W, the standard image capturing module M and the telephoto image capturing module T can be arranged in a vertical line (FIG. 5A), a horizontal line (FIG. 5B) or a shape of a triangle (FIG. 5C). According to the present disclosure, the arrangement and the positions of the wide-angle image capturing module W, the standard image capturing module M and the telephoto image capturing module T can all be adjusted based on actual requirements.

According to the camera unit of the present disclosure, the camera unit can be optionally applied to an optical system for movably focusing. Furthermore, the camera unit is featured with good capability in the correction of aberration and high image quality, and can be applied to 3D (three-dimensional) image capturing applications. For example, a plurality of raw images are captured from at least two of the wide-angle image capturing module, the standard image capturing module and the telephoto image capturing module of the camera unit, and a final photographed image is produced by post-processing of the raw images (such as 3D image post processing). The camera unit can be applied to various devices, in products such as digital cameras, mobile devices, digital tablets, wearable devices, smart televisions, wireless monitoring devices, motion sensing input devices, driving recorders, rear view cameras and other electronic imaging devices. According to the above description of the present disclosure, the following specific embodiments are provided for further explanation.

### 1st Embodiment

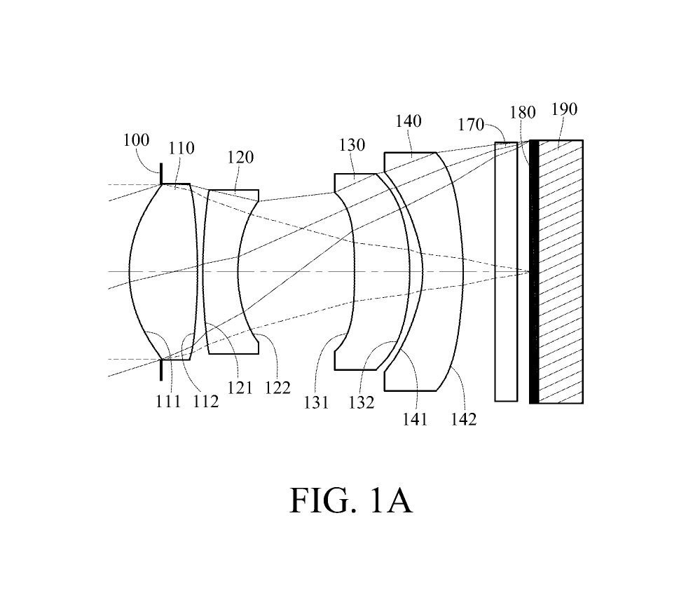

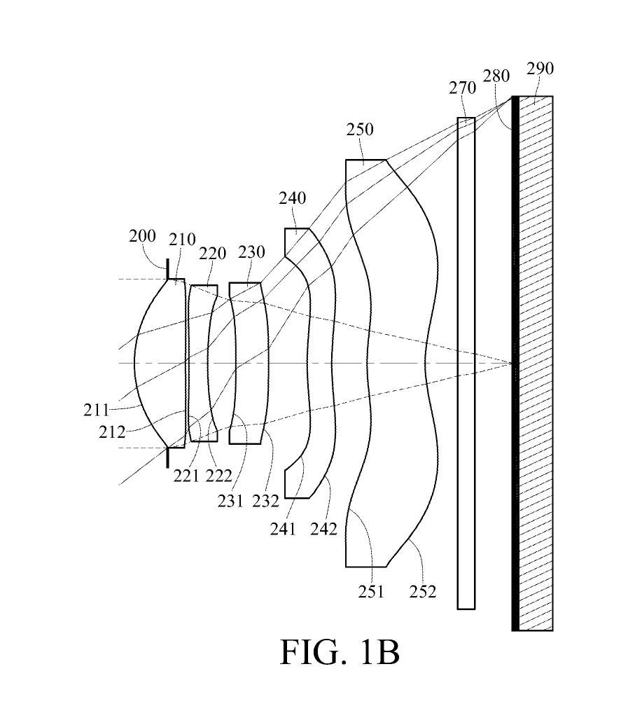

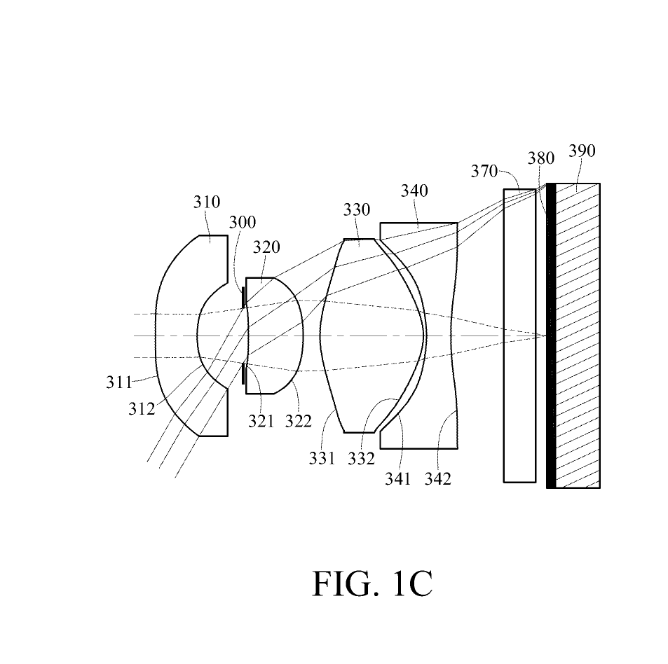

FIG. 1A is a schematic view of a telephoto image capturing module according to the 1st embodiment of the present disclosure. FIG. 1B is a schematic view of a standard image capturing module according to the 1st embodiment of the present disclosure. FIG. 1C is a schematic view of a wide-angle image capturing module according to the 1st embodiment of the present disclosure. In this embodiment, a camera unit includes a telephoto image capturing module, a standard image capturing module and a wide-angle image capturing module (the reference numerals are all omitted).

In FIG. 1A, the telephoto image capturing module includes a telephoto lens assembly and a telephoto image sensor 190. The telephoto lens assembly includes, in order from an object side to an image side thereof, an aperture stop 100, a first lens element 110, a second lens element 120, a third lens element 130, a fourth lens element 140, a filter 170 and an image surface 180, wherein the telephoto lens assembly has a total of four lens elements (110-140) with refractive power. The first lens element 110, the second lens element 120, the third lens element 130 and the fourth lens element 140 are all stationary relative to one another in a paraxial region thereof. In this embodiment, the first lens element 110 of the telephoto lens assembly is the first lens element thereof closest to the object-side, and the fourth lens element 140 of the telephoto lens assembly is the last lens element thereof closest to the image-side.

The first lens element 110 with positive refractive power has an object-side surface 111 being convex in a paraxial region thereof and an image-side surface 112 being convex in a paraxial region thereof. The first lens element 110 is made of plastic material and has the object-side surface 111 and the image-side surface 112 being both aspheric.

The second lens element 120 with negative refractive power has an object-side surface 121 being convex in a paraxial region thereof and an image-side surface 122 being concave in a paraxial region thereof. The second lens element 120 is made of plastic material and has the object-side surface 121 and the image-side surface 122 being both aspheric.

The third lens element 130 with positive refractive power has an object-side surface 131 being concave in a paraxial region thereof and an image-side surface 132 being convex in a paraxial region thereof. The third lens element 130 is made of plastic material and has the object-side surface 131 and the image-side surface 132 being both aspheric.

The fourth lens element 140 with negative refractive power has an object-side surface 141 being concave in a paraxial region thereof and an image-side surface 142 being convex in a paraxial region thereof. The fourth lens element 140 is made of plastic material and has the object-side surface 141 and the image-side surface 142 being both aspheric.

The filter 170 is made of glass and located between the fourth lens element 140 and the image surface 180, and will not affect the focal length of the telephoto lens assembly. The telephoto image sensor 190 is disposed on or near the image surface 180 of the telephoto lens assembly.

In FIG. 1B, the standard image capturing module includes a standard lens assembly and a standard image sensor 290. The standard lens assembly includes, in order from an object side to an image side thereof, an aperture stop 200, a first lens element 210, a second lens element 220, a third lens element 230, a fourth lens element 240, a fifth lens element 250, an IR-cut filter 270 and an image surface 280, wherein the standard lens assembly has a total of fifth lens elements (210-250) with refractive power. The first lens element 210, the second lens element 220, the third lens element 230, the fourth lens element 240 and the fifth lens element 250 are all stationary relative to one another in a paraxial region thereof. In this embodiment, the first lens element 210 of the standard lens assembly is the first lens element thereof closest to the object-side, and the fifth lens element 250 of the standard lens assembly is the last lens element thereof closest to the image-side.

The first lens element 210 with positive refractive power has an object-side surface 211 being convex in a paraxial region thereof and an image-side surface 212 being concave in a paraxial region thereof. The first lens element 210 is made of plastic material and has the object-side surface 211 and the image-side surface 212 being both aspheric.

The second lens element 220 with negative refractive power has an object-side surface 221 being convex in a paraxial region thereof and an image-side surface 222 being concave in a paraxial region thereof. The second lens element 220 is made of plastic material and has the object-side surface 221 and the image-side surface 222 being both aspheric.

The third lens element 230 with negative refractive power has an object-side surface 231 being concave in a paraxial region thereof and an image-side surface 232 being convex in a paraxial region thereof. The third lens element 230 is made of plastic material and has the object-side surface 231 and the image-side surface 232 being both aspheric.

The fourth lens element 240 with negative refractive power has an object-side surface 241 being convex in a paraxial region thereof and an image-side surface 242 being concave in a paraxial region thereof. The fourth lens element 240 is made of plastic material and has the object-side surface 241 and the image-side surface 242 being both aspheric.

The fifth lens element 250 with negative refractive power has an object-side surface 251 being convex in a paraxial region thereof and an image-side surface 252 being concave in a paraxial region thereof. The fifth lens element 250 is made of plastic material and has the object-side surface 251 and the image-side surface 252 being both aspheric. The image-side surface 252 of the fifth lens element 250 has a wave-like shape.

The IR-cut filter 270 is made of glass and located between the fifth lens element 250 and the image surface 280, and will not affect the focal length of the standard lens assembly. The standard image sensor 290 is disposed on or near the image surface 280 of the standard lens assembly.

In FIG. 1C, the wide-angle image capturing module includes a wide-angle lens assembly and a wide-angle image sensor 390. The wide-angle lens assembly includes, in order from an object side to an image side thereof, a first lens element 310, an aperture stop 300, a second lens element 320, a third lens element 330, a fourth lens element 340, an IR-cut filter 370 and an image surface 380, wherein the wide-angle lens assembly has a total of four lens elements (310-340) with refractive power. The first lens element 310, the second lens element 320, the third lens element 330 and the fourth lens element 340 are all stationary relative to one another in a paraxial region thereof. In this embodiment, the first lens element 310 of the wide-angle lens assembly is the first lens element thereof closest to the object-side, and the fourth lens element 340 of the wide-angle lens assembly is the last lens element thereof closest to the image-side.

The first lens element 310 with negative refractive power has an object-side surface 311 being convex in a paraxial region thereof and an image-side surface 312 being concave in a paraxial region thereof. The first lens element 310 is made of plastic material and has the object-side surface 311 and the image-side surface 312 being both aspheric.

The second lens element 320 with positive refractive power has an object-side surface 321 being concave in a paraxial region thereof and an image-side surface 322 being convex in a paraxial region thereof. The second lens element 320 is made of plastic material and has the object-side surface 321 and the image-side surface 322 being both aspheric.

The third lens element 330 with positive refractive power has an object-side surface 331 being convex in a paraxial region thereof and an image-side surface 332 being convex in a paraxial region thereof. The third lens element 330 is made of plastic material and has the object-side surface 331 and the image-side surface 332 being both aspheric.

The fourth lens element 340 with negative refractive power has an object-side surface 341 being concave in a paraxial region thereof and an image-side surface 342 being concave in a paraxial region thereof. The fourth lens element 340 is made of plastic material and has the object-side surface 341 and the image-side surface 342 being both aspheric. The image-side surface 342 of the fourth lens element 340 has a wave-like shape.

The IR-cut filter 370 is made of glass and located between the fourth lens element 340 and the image surface 380, and will not affect the focal length of the wide-angle lens assembly. The wide-angle image sensor 390 is disposed on or near the image surface 380 of the wide-angle lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,

X is the relative distance between a point on the aspheric surface spaced at a distance Y from an optical axis and the tangential plane at the aspheric surface vertex on the optical axis;

Y is the vertical distance from the point on the aspheric surface to the optical axis;

R is the curvature radius;

k is the conic coefficient; and

Ai is the i-th aspheric coefficient, and in the embodiments, i may be, but is not limited to, 4, 6, 8, 10, 12, 14 and 16.

In the telephoto image capturing module of the camera unit according to the 1st embodiment, when a focal length of the telephoto lens assembly is f(T), an f-number of the telephoto lens assembly is Fno(T), and half of a maximal field of view of the telephoto lens assembly is HFOV(T), these parameters have the following values: f(T)=3.84 millimeters (mm); Fno(T)=2.32; and HFOV(T)=17.7 degrees (deg.).

In the standard image capturing module of the camera unit according to the 1st embodiment, when a focal length of the standard lens assembly is f(M), an f-number of the standard lens assembly is Fno(M), and half of a maximal field of view of the standard lens assembly is HFOV(M), these parameters have the following values: f(M)=4.19 mm; Fno(M)=2.02; and HFOV(M)=37.5 deg.

In the wide-angle image capturing module of the camera unit according to the 1st embodiment, when a focal length of the wide-angle lens assembly is f(W), an f-number of the wide-angle lens assembly is Fno(W), and half of a maximal field of view of the wide-angle lens assembly is HFOV(W), these parameters have the following values: f(W)=0.96 mm; Fno(W)=2.30; and HFOV(W)=60.1 deg.

When the maximal field of view of the telephoto lens assembly is FOV(T), the following condition is satisfied: FOV(T)=35.4 deg.

When the maximal field of view of the standard lens assembly is FOV(M), the following condition is satisfied: FOV(M)=75.0 deg.

When the maximal field of view of the wide-angle lens assembly is FOV(W), the following condition is satisfied: FOV(W)=120.2 deg.

When an axial distance between the object-side surface 111 of the first lens element 110 of the telephoto lens assembly and the telephoto image sensor 190 is TL(T), the following condition is satisfied: TL(T)=3.78 mm.

When an axial distance between the object-side surface 211 of the first lens element 210 of the standard lens assembly and the standard image sensor 290 is TL(M), the following condition is satisfied: TL(M)=4.64 mm.

When an axial distance between the object-side surface 311 of the first lens element 310 of the wide-angle lens assembly and the wide-angle image sensor 390 is TL(W), the following condition is satisfied: TL(W)=3.69 mm.

When an axial distance between the image-side surface 142 of the fourth lens element 140 of the telephoto lens assembly and the telephoto image sensor 190 is BL(T), the following condition is satisfied: BL(T)=0.63 mm.

When an axial distance between the image-side surface 252 of the fifth lens element 250 of the standard lens assembly and the standard image sensor 290 is BL(M), the following condition is satisfied: BL(M)=1.07 mm.

When an axial distance between the image-side surface 342 of the fourth lens element 340 of the wide-angle lens assembly and the wide-angle image sensor 390 is BL(W), the following condition is satisfied: BL(W)=0.91 mm.

When a diagonal length of an effective photosensitive area of the telephoto image sensor 190 is D(T), the following condition is satisfied: D(T)=2.86 mm.

When a diagonal length of an effective photosensitive area of the standard image sensor 290 is D(M), the following condition is satisfied: D(M)=6.52 mm.

When a diagonal length of an effective photosensitive area of the wide-angle image sensor 390 is D(W), the following condition is satisfied: D(W)=2.48 mm.

When the maximal field of view of the wide-angle lens assembly is FOV(W), the maximal field of view of the telephoto lens assembly is FOV(T), the following condition is satisfied: FOV(W)/FOV(T)=3.40.

When the f-number of the telephoto lens assembly is Fno(T) the following condition is satisfied: Fno(T)=2.32.

When the f-number of the standard lens assembly is Fno(M) the following condition is satisfied: Fno(M)=2.02.

When the f-number of the wide-angle lens assembly is Fno(W) the following condition is satisfied: Fno(W)=2.30.

When the focal length of the telephoto lens assembly is f(T), the focal length of the wide-angle lens assembly is f(W), the following condition is satisfied: f(T)/f(W)=4.00.

When the maximal field of view of the standard lens assembly is FOV(M), the maximal field of view of the telephoto lens assembly is FOV(T), the following condition is satisfied: FOV(M)−FOV(T)=39.6 deg.

When the maximal field of view of the wide-angle lens assembly is FOV(W), the maximal field of view of the standard lens assembly is FOV(M), the following condition is satisfied: FOV(W)−FOV(M)=45.2 deg.

When a pixel size of the telephoto image sensor 190 is Pixel(T), the following condition is satisfied: Pixel(T)=1.20 micrometers (μm).

When a pixel size of the standard image sensor 290 is Pixel(M), the following condition is satisfied: Pixel(M)=1.12 μm.

When a pixel size of the wide-angle image sensor 390 is Pixel(W), the following condition is satisfied: Pixel(W)=1.75 μm.

The detailed optical data of the 1st embodiment are shown in Table 1, Table 3 and Table 5 below. The aspheric surface data of the 1st embodiment are shown in Table 2, Table 4 and Table 6 below.

TABLE 1
Optical Data of the Telephoto Lens Assembly according to the 1st Embodiment
f(T) = 3.84 mm, Fno(T) = 2.32, HFOV(T) = 17.7 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Ape. Stop | Plano | | −0.302 | | | | |
| 2 | Lens 1 | 1.163 | (ASP) | 0.644 | Plastic | 1.514 | 56.8 | 1.95 |
| 3 | | −5.934 | (ASP) | 0.050 | | | | |
| 4 | Lens 2 | 4.359 | (ASP) | 0.331 | Plastic | 1.650 | 21.5 | −3.01 |
| 5 | | 1.310 | (ASP) | 1.102 | | | | |
| 6 | Lens 3 | −6.264 | (ASP) | 0.521 | Plastic | 1.650 | 21.5 | 5.05 |
| 7 | | −2.224 | (ASP) | 0.123 | | | | |
| 8 | Lens 4 | −0.960 | (ASP) | 0.382 | Plastic | 1.514 | 56.8 | −3.35 |
| 9 | | −2.466 | (ASP) | 0.300 | | | | |

| | | | | | | | |
|---|---|---|---|---|---|---|---|
| 10 | Filter | Plano | 0.210 | Glass | 1.517 | 64.2 | — |
| 11 | | Plano | 0.119 | | | | |
| 12 | Image | Plano | — | | | | |

Note:
Reference wavelength is 587.6 nm (d-line).

TABLE 2
Aspheric Coefficients of the Telephoto Lens
Assembly according to the 1st Embodiment

| Surface # | 2 | 3 | 4 | 5 |
|---|---|---|---|---|
| k = | −2.3529E+00 | 1.8897E+01 | −5.0000E+01 | −4.4938E−01 |
| A4 = | 1.6123E−01 | −3.9801E−03 | −4.6769E−02 | −5.0144E−02 |
| A6 = | 2.1175E−04 | 1.8424E−01 | 2.5042E−01 | 1.0705E−01 |
| A8 = | −1.8619E−01 | −6.5510E−01 | −4.6205E−01 | 1.8165E+00 |
| A10 = | 3.4044E−01 | 1.0589E+00 | 4.1566E−01 | −8.4125E+00 |
| A12 = | −2.3688E−01 | −1.1615E+00 | −6.4786E−02 | 1.8990E+01 |
| A14 = | −1.0394E−01 | 5.1454E−01 | 1.4934E−02 | −1.5029E+01 |
| Surface # | 6 | 7 | 8 | 9 |
| k = | 1.6167E+01 | 9.2113E−01 | −1.7795E−01 | −4.8785E+01 |
| A4 = | −2.8189E−01 | −1.1466E−01 | 6.1855E−01 | 8.3284E−02 |
| A6 = | −2.7193E−02 | 6.2295E−01 | −5.1667E−01 | −3.8602E−01 |
| A8 = | −4.0635E−01 | −2.8704E+00 | −8.5501E−01 | 4.2455E−01 |
| A10 = | −1.0824E−01 | 5.4758E+00 | 3.6480E+00 | −2.1659E−01 |
| A12 = | −3.8909E−01 | −5.3546E+00 | −4.3942E+00 | 1.8336E−02 |
| A14 = | 7.9982E−01 | 2.1319E+00 | 1.8837E+00 | 9.4135E−03 |

TABLE 3
Optical Data of the Standard Lens Assembly according to the 1st Embodiment
f(M) = 4.19 mm, Fno(M) = 2.02, HFOV(M) = 37.5 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Ape. Stop | Plano | | −0.409 | | | | |
| 2 | Lens 1 | 1.422 | (ASP) | 0.628 | Plastic | 1.544 | 55.9 | 2.88 |
| 3 | | 12.785 | (ASP) | 0.042 | | | | |
| 4 | Lens 2 | 65.061 | (ASP) | 0.230 | Plastic | 1.639 | 23.5 | −6.56 |
| 5 | | 3.932 | (ASP) | 0.347 | | | | |
| 6 | Lens 3 | −19.301 | (ASP) | 0.402 | Plastic | 1.639 | 23.5 | −2152.23 |
| 7 | | −19.735 | (ASP) | 0.474 | | | | |
| 8 | Lens 4 | 3.200 | (ASP) | 0.301 | Plastic | 1.639 | 23.5 | −37.23 |
| 9 | | 2.717 | (ASP) | 0.434 | | | | |
| 10 | Lens 5 | 2.0818 | (ASP) | 0.713 | Plastic | 1.535 | 55.7 | −21.81 |
| 11 | | 1.556 | (ASP) | 0.400 | | | | |

| | | | | | | | |
|---|---|---|---|---|---|---|---|
| 12 | IR-cut filter | Plano | 0.210 | Glass | 1.517 | 64.2 | — |
| 13 | | Plano | 0.459 | | | | |
| 14 | Image | Plano | — | | | | |

Note:
Reference wavelength is 587.6 nm (d-line).
Effective radius of Surface 7 is 0.990 mm.

TABLE 4
Aspheric Coefficients of the Standard Lens Assembly according to the 1st Embodiment

| Surface # | 1 | 2 | 4 | 5 | 6 |
|---|---|---|---|---|---|
| k = | −4.3410E+00 | 8.9901E+01 | −2.0380E+01 | −3.2967E+01 | 3.4515E+01 |
| A4 = | 1.7063E−01 | −2.0149E−01 | −2.2908E−01 | −6.5327E−03 | −1.5939E−01 |
| A6 = | −1.6929E−03 | 3.8437E−01 | 6.3941E−01 | 2.7135E−01 | 6.4187E−02 |
| A8 = | −1.7319E−01 | −3.2421E−01 | −6.7740E−01 | −2.2748E−01 | −1.8357E−01 |
| A10 = | 2.6395E−01 | 9.8898E−02 | 3.7293E−01 | −3.1428E−02 | 4.5398E−01 |
| A12 = | −1.3905E−01 | −1.7931E−02 | −6.5920E−02 | 2.1420E−01 | −5.2698E−01 |
| A14 = | — | — | — | — | 2.9575E−01 |
| Surface # | 7 | 8 | 9 | 10 | 11 |
| k = | 5.3708E+01 | −9.0000E+01 | −8.9881E+01 | −2.4765E+01 | −7.6073E+00 |
| A4 = | −1.4997E−01 | 3.1097E−02 | 6.1132E−04 | −1.5404E−01 | −9.8884E−02 |
| A6 = | 1.0273E−01 | −1.7291E−01 | −7.3771E−02 | 3.4391E−02 | 4.2029E−02 |
| A8 = | −2.0582E−01 | 9.7627E−02 | 4.5126E−02 | 5.9047E−03 | −1.7838E−02 |
| A10 = | 3.6118E−01 | −2.8834E−02 | −2.2341E−02 | −3.2867E−03 | 5.2802E−03 |
| A12 = | −3.0273E−01 | −1.4635E−02 | 7.3166E−03 | 4.5032E−04 | −9.5575E−04 |
| A14 = | 1.2149E−01 | 8.2738E−03 | −8.2201E−04 | −1.7484E−05 | 9.3717E−05 |
| A16 = | — | — | −4.7331E−05 | −4.5361E−07 | −3.7484E−06 |

TABLE 5
Optical Data of the Wide-Angle Lens Assembly according to the 1st Embodiment
f(W) = 0.96 mm, Fno(W) = 2.30, HFOV(W) = 60.1 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Lens 1 | 31.580 | (ASP) | 0.394 | Plastic | 1.535 | 55.7 | −1.78 |
| 2 | | 0.921 | (ASP) | 0.434 | | | | |
| 3 | Ape. Stop | Plano | | 0.050 | | | | |
| 4 | Lens 2 | −4.848 | (ASP) | 0.516 | Plastic | 1.535 | 55.7 | 3.55 |
| 5 | | −1.415 | (ASP) | 0.159 | | | | |
| 6 | Lens 3 | 0.926 | (ASP) | 0.976 | Plastic | 1.544 | 55.9 | 0.81 |
| 7 | | −0.527 | (ASP) | 0.030 | | | | |
| 8 | Lens 4 | −1.027 | (ASP) | 0.230 | Plastic | 1.650 | 21.4 | −1.17 |
| 9 | | 3.149 | (ASP) | 0.500 | | | | |

| | | | | | | | |
|---|---|---|---|---|---|---|---|
| 10 | IR-cut filter | Plano | 0.300 | Glass | 1.517 | 64.2 | — |
| 11 | | Plano | 0.106 | | | | |
| 12 | Image | Plano | — | | | | |

Note:
Reference wavelength is 587.6 nm (d-line).

TABLE 6
Aspheric Coefficients of the Wide-Angle Lens
Assembly according to the 1st Embodiment

| Surface # | 1 | 2 | 4 | 5 |
|---|---|---|---|---|
| k = | −7.9189E+01 | −5.5854E−01 | −3.5830E+01 | 5.0231E+00 |
| A4 = | 1.3086E+00 | 3.0007E+00 | −1.3010E+00 | −1.4008E+00 |
| A6 = | −2.8439E+00 | −5.4343E+00 | 1.2169E+01 | 1.0903E+00 |
| A8 = | 4.6557E+00 | 6.7370E+00 | −2.1243E+02 | 1.6089E+00 |
| A10 = | −4.1183E+00 | 5.9550E+01 | 8.1938E+02 | −1.3702E+01 |
| A12 = | 1.4880E+00 | −1.7435E+02 | 6.2334E+02 | 3.9044E+00 |
| A14 = | — | — | −7.0874E+02 | −1.7012E+00 |
| Surface # | 6 | 7 | 8 | 9 |
| k = | −8.9417E+00 | −3.1335E+00 | −9.9745E−01 | −9.0000E+01 |
| A4 = | 4.3733E−02 | 5.0926E−01 | 1.6132E+00 | 7.9205E−01 |
| A6 = | −9.7338E−02 | −2.5112E+00 | −9.6740E+00 | −4.2154E+00 |
| A8 = | −4.8012E−01 | 5.2340E+00 | 2.3580E+01 | 1.0079E+01 |
| A10 = | 1.2434E+00 | −6.0310E+00 | −2.7837E+01 | −1.3753E+01 |
| A12 = | −9.1187E−01 | 2.9616E+00 | 1.1389E+01 | 1.1012E+01 |
| A14 = | 2.5721E−01 | −1.1138E−01 | 4.9429E+00 | −4.8468E+00 |
| A16 = | — | — | −4.0310E+00 | 9.1478E−01 |

In Table 1, Table 3 and Table 5, the curvature radius, the thickness and the focal length are shown in millimeters (mm). Surface numbers 0-14 represent the surfaces sequentially arranged from the object-side to the image-side along the optical axis. In Table 2, Table 4 and Table 6, k represents the conic coefficient of the equation of the aspheric surface profiles. A4-A16 represent the aspheric coefficients ranging from the 4th order to the 16th order. The tables presented below for each embodiment are the corresponding schematic parameter and aberration curves, and the definitions of the tables are the same as Table 1 through Table 6 of the 1st embodiment. Therefore, an explanation in this regard will not be provided again.

### 2nd Embodiment

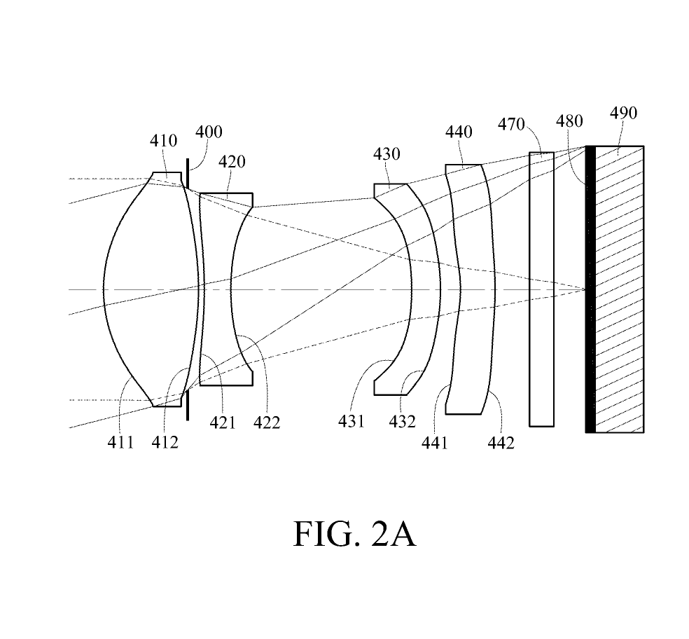

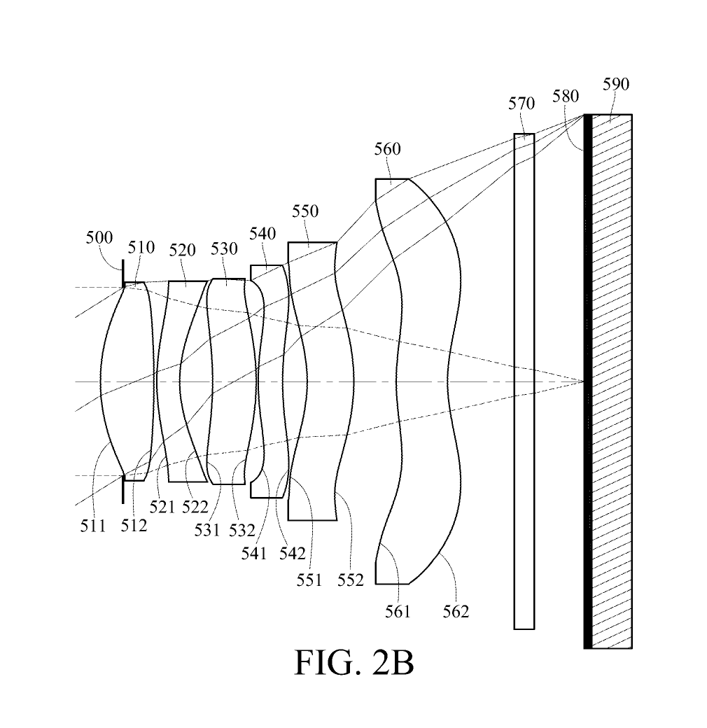

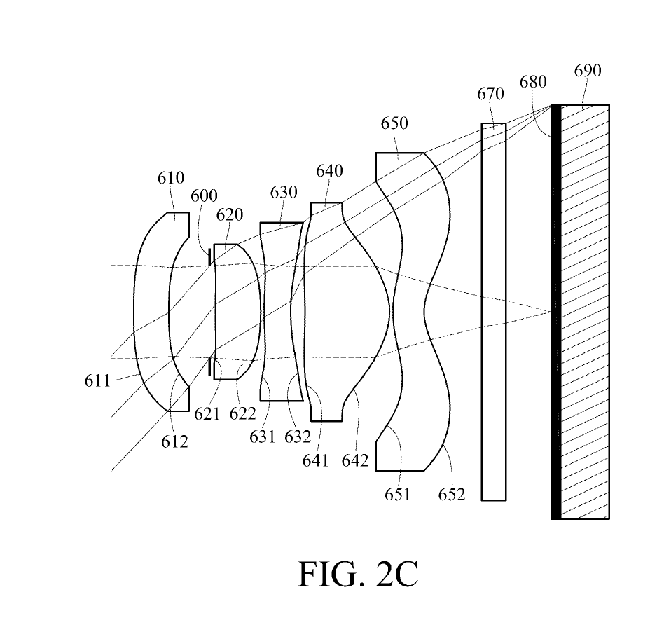

FIG. 2A is a schematic view of a telephoto image capturing module according to the 2nd embodiment of the present disclosure. FIG. 2B is a schematic view of a standard image capturing module according to the 2nd embodiment of the present disclosure. FIG. 2C is a schematic view of a wide-angle image capturing module according to the 2nd embodiment of the present disclosure. In this embodiment, a camera unit includes a telephoto image capturing module, a standard image capturing module and a wide-angle image capturing module (the reference numerals are all omitted).

In FIG. 2A, the telephoto image capturing module includes a telephoto lens assembly and a telephoto image sensor 490. The telephoto lens assembly includes, in order from an object side to an image side thereof, a first lens element 410, an aperture stop 400, a second lens element 420, a third lens element 430, a fourth lens element 440, a filter 470 and an image surface 480, wherein the telephoto lens assembly has a total of four lens elements (410-440) with refractive power. The first lens element 410, the second lens element 420, the third lens element 430 and the fourth lens element 440 are all stationary relative to one another in a paraxial region thereof. In this embodiment, the first lens element 410 of the telephoto lens assembly is the first lens element thereof closest to the object-side, and the fourth lens element 440 of the telephoto lens assembly is the last lens element thereof closest to the image-side.

The first lens element 410 with positive refractive power has an object-side surface 411 being convex in a paraxial region thereof and an image-side surface 412 being convex in a paraxial region thereof. The first lens element 410 is made of plastic material and has the object-side surface 411 and the image-side surface 412 being both aspheric.

The second lens element 420 with negative refractive power has an object-side surface 421 being concave in a paraxial region thereof and an image-side surface 422 being concave in a paraxial region thereof. The second lens element 420 is made of plastic material and has the object-side surface 421 and the image-side surface 422 being both aspheric.

The third lens element 430 with positive refractive power has an object-side surface 431 being concave in a paraxial region thereof and an image-side surface 432 being convex in a paraxial region thereof. The third lens element 430 is made of plastic material and has the object-side surface 431 and the image-side surface 432 being both aspheric.

The fourth lens element 440 with negative refractive power has an object-side surface 441 being concave in a paraxial region thereof and an image-side surface 442 being convex in a paraxial region thereof. The fourth lens element 440 is made of plastic material and has the object-side surface 441 and the image-side surface 442 being both aspheric.

The filter 470 is made of glass and located between the fourth lens element 440 and the image surface 480, and will not affect the focal length of the telephoto lens assembly. The telephoto image sensor 490 is disposed on or near the image surface 480 of the telephoto lens assembly.

In FIG. 2B, the standard image capturing module includes a standard lens assembly and a standard image sensor 590. The standard lens assembly includes, in order from an object side to an image side thereof, an aperture stop 500, a first lens element 510, a second lens element 520, a third lens element 530, a fourth lens element 540, a fifth lens element 550, a sixth lens element 560, an IR-cut filter 570 and an image surface 580, wherein the standard lens assembly has a total of six lens elements (510-560) with refractive power. The first lens element 510, the second lens element 520, the third lens element 530, the fourth lens element 540, the fifth lens element 550 and the sixth lens element 560 are all stationary relative to one another in a paraxial region thereof. In this embodiment, the first lens element 510 of the standard lens assembly is the first lens element thereof closest to the object-side, and the sixth lens element 560 of the standard lens assembly is the last lens element thereof closest to the image-side.

The first lens element 510 with positive refractive power has an object-side surface 511 being convex in a paraxial region thereof and an image-side surface 512 being convex in a paraxial region thereof. The first lens element 510 is made of plastic material and has the object-side surface 511 and the image-side surface 512 being both aspheric.

The second lens element 520 with negative refractive power has an object-side surface 521 being convex in a paraxial region thereof and an image-side surface 522 being concave in a paraxial region thereof. The second lens element 520 is made of plastic material and has the object-side surface 521 and the image-side surface 522 being both aspheric.

The third lens element 530 with positive refractive power has an object-side surface 531 being concave in a paraxial region thereof and an image-side surface 532 being convex in a paraxial region thereof. The third lens element 530 is made of plastic material and has the object-side surface 531 and the image-side surface 532 being both aspheric.

The fourth lens element 540 with positive refractive power has an object-side surface 541 being convex in a paraxial region thereof and an image-side surface 542 being concave in a paraxial region thereof. The fourth lens element 540 is made of plastic material and has the object-side surface 541 and the image-side surface 542 being both aspheric.

The fifth lens element 550 with negative refractive power has an object-side surface 551 being concave in a paraxial region thereof and an image-side surface 552 being convex in a paraxial region thereof. The fifth lens element 550 is made of plastic material and has the object-side surface 551 and the image-side surface 552 being both aspheric.

The sixth lens element 560 with negative refractive power has an object-side surface 561 being convex in a paraxial region thereof and an image-side surface 562 being concave in a paraxial region thereof. The sixth lens element 560 is made of plastic material and has the object-side surface 561 and the image-side surface 562 being both aspheric. The image-side surface 562 of the sixth lens element 560 has a wave-like shape.

The IR-cut filter 570 is made of glass and located between the sixth lens element 560 and the image surface 580, and will not affect the focal length of the standard lens assembly. The standard image sensor 590 is disposed on or near the image surface 580 of the standard lens assembly.

In FIG. 2C, the wide-angle image capturing module includes a wide-angle lens assembly and a wide-angle image sensor 690. The wide-angle lens assembly includes, in order from an object side to an image side thereof, a first lens element 610, an aperture stop 600, a second lens element 620, a third lens element 630, a fourth lens element 640, a fifth lens element 650, an IR-cut filter 670 and an image surface 680, wherein the wide-angle lens assembly has a total of five lens elements (610-650) with refractive power. The first lens element 610, the second lens element 620, the third lens element 630, the fourth lens element 640 and the fifth lens element 650 are all stationary relative to one another in a paraxial region thereof. In this embodiment, the first lens element 610 of the wide-angle lens assembly is the first lens element thereof closest to the object-side, and the fifth lens element 650 of the wide-angle lens assembly is the last lens element thereof closest to the image-side.

The first lens element 610 with negative refractive power has an object-side surface 611 being convex in a paraxial region thereof and an image-side surface 612 being concave in a paraxial region thereof. The first lens element 610 is made of plastic material and has the object-side surface 611 and the image-side surface 612 being both aspheric.

The second lens element 620 with positive refractive power has an object-side surface 621 being convex in a paraxial region thereof and an image-side surface 622 being convex in a paraxial region thereof. The second lens element 620 is made of plastic material and has the object-side surface 621 and the image-side surface 622 being both aspheric.

The third lens element 630 with negative refractive power has an object-side surface 631 being convex in a paraxial region thereof and an image-side surface 632 being concave in a paraxial region thereof. The third lens element 630 is made of plastic material and has the object-side surface 631 and the image-side surface 632 being both aspheric.

The fourth lens element 640 with positive refractive power has an object-side surface 641 being concave in a paraxial region thereof and an image-side surface 642 being convex in a paraxial region thereof. The fourth lens element 640 is made of plastic material and has the object-side surface 641 and the image-side surface 642 being both aspheric.

The fifth lens element 650 with negative refractive power has an object-side surface 651 being convex in a paraxial region thereof and an image-side surface 652 being concave in a paraxial region thereof. The fifth lens element 650 is made of plastic material and has the object-side surface 651 and the image-side surface 652 being both aspheric. The image-side surface 652 of the fifth lens element 650 has a wave-like shape.

The IR-cut filter 670 is made of glass and located between the fifth lens element 650 and the image surface 680, and will not affect the focal length of the wide-angle lens assembly. The wide-angle image sensor 690 is disposed on or near the image surface 680 of the wide-angle lens assembly.

The detailed optical data of the 2nd embodiment are shown in Table 7, Table 9 and Table 11 below. The aspheric surface data of the 2nd embodiment are shown in Table 8, Table 10 and Table 12 below.

TABLE 7
Optical Data of the Telephoto Lens Assembly according to the 2nd Embodiment
f(T) = 4.62 mm, Fno(T) = 2.45, HFOV(T) = 14.5 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Lens 1 | 1.217 | (ASP) | 0.823 | Plastic | 1.528 | 55.7 | 1.70 |
| 2 | | −2.589 | (ASP) | −0.094 | | | | |
| 3 | Ape. Stop | Plano | | 0.144 | | | | |
| 4 | Lens 2 | −4.044 | (ASP) | 0.230 | Plastic | 1.621 | 23.5 | −2.09 |
| 5 | | 1.952 | (ASP) | 1.567 | | | | |
| 6 | Lens 3 | −2.037 | (ASP) | 0.250 | Plastic | 1.621 | 23.5 | 11.37 |
| 7 | | −1.655 | (ASP) | 0.173 | | | | |
| 8 | Lens 4 | −1.179 | (ASP) | 0.300 | Plastic | 1.537 | 55.9 | −4.01 |
| 9 | | −2.835 | (ASP) | 0.300 | | | | |

| | | | | | | | |
|---|---|---|---|---|---|---|---|
| 10 | Filter | Plano | 0.210 | Glass | 1.510 | 64.2 | — |
| 11 | | Plano | 0.278 | | | | |
| 12 | Image | Plano | — | | | | |

Note:
Reference wavelength is 820 nm.
Effective radius of Surface 3 is 0.873 mm.

TABLE 8
Aspheric Coefficients of the Telephoto Lens
Assembly according to the 2nd Embodiment

| Surface # | 1 | 2 | 4 | 5 |
|---|---|---|---|---|
| k = | −2.5682E+00 | −9.4488E+00 | −1.6957E+01 | 1.1619E+00 |
| A4 = | 1.5570E−01 | −1.1962E−02 | −1.1701E−02 | 6.6095E−02 |
| A6 = | 1.6252E−02 | 1.5258E−01 | 5.6359E−02 | −4.9373E−01 |
| A8 = | −2.1589E−01 | −1.5872E−01 | 1.4459E+00 | 5.5707E+00 |
| A10 = | 4.2254E−01 | −2.7911E−01 | −5.2508E+00 | −1.9470E+01 |
| A12 = | −3.6430E−01 | 4.6506E−01 | 7.1494E+00 | 3.2232E+01 |
| A14 = | 7.3040E−02 | −1.9160E−01 | −3.3942E+00 | −1.9570E+01 |
| Surface # | 6 | 7 | 8 | 9 |
| k = | 3.2059E−01 | −1.8009E+01 | 8.5164E−03 | −1.1926E+00 |
| A4 = | −3.2273E−01 | −2.2646E−01 | 1.2738E+00 | 4.6532E−01 |
| A6 = | −2.1129E−01 | 1.1753E+00 | −1.5777E+00 | −7.4545E−01 |
| A8 = | 1.5820E+00 | −4.3243E+00 | 4.8502E−01 | 5.3366E−01 |
| A10 = | −6.9016E+00 | 6.1807E+00 | 8.6293E−01 | −2.0739E−01 |
| A12 = | 9.9166E+00 | −4.2357E+00 | −9.0078E−01 | 3.9000E−02 |
| A14 = | −4.2205E+00 | 1.2548E+00 | 2.8385E−01 | −2.3421E−03 |

TABLE 9
Optical Data of the Standard Lens Assembly according to the 2nd Embodiment
f(M) = 4.33 mm, Fno(M) = 2.20, HFOV(M) = 32.1 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Ape. Stop | Plano | | −0.237 | | | | |
| 2 | Lens 1 | 1.855 | (ASP) | 0.561 | Plastic | 1.535 | 55.7 | 2.93 |
| 3 | | −9.019 | (ASP) | 0.030 | | | | |
| 4 | Lens 2 | 2.105 | (ASP) | 0.240 | Plastic | 1.650 | 21.4 | −5.65 |
| 5 | | 1.278 | (ASP) | 0.346 | | | | |
| 6 | Lens 3 | −3.334 | (ASP) | 0.457 | Plastic | 1.530 | 55.8 | 16.04 |
| 7 | | −2.509 | (ASP) | 0.021 | | | | |
| 8 | Lens 4 | 2.403 | (ASP) | 0.256 | Plastic | 1.544 | 55.9 | 17.01 |
| 9 | | 3.123 | (ASP) | 0.258 | | | | |
| 10 | Lens 5 | −1.548 | (ASP) | 0.489 | Plastic | 1.650 | 21.4 | −18.76 |
| 11 | | −1.994 | (ASP) | 0.445 | | | | |
| 12 | Lens 6 | 2.281 | (ASP) | 0.538 | Plastic | 1.530 | 55.8 | −15.25 |
| 13 | | 1.634 | (ASP) | 0.700 | | | | |

| | | | | | | | |
|---|---|---|---|---|---|---|---|
| 14 | IR-cut filter | Plano | 0.210 | Glass | 1.517 | 64.2 | — |
| 15 | | Plano | 0.523 | | | | |
| 16 | Image | Plano | — | | | | |

Note:
Reference wavelength is 587.6 nm (d-line).

TABLE 10
Aspheric Coefficients of the Standard Lens Assembly according to the 2nd Embodiment

| | Surface # | | | | | |
|---|---|---|---|---|---|---|
| | 2 | 3 | 4 | 5 | 6 | 7 |
| k = | −2.4590E−01 | −9.0000E+01 | −1.2615E+01 | −3.8549E+00 | −4.1326E+01 | −2.1711E+01 |
| A4 = | −1.8945E−05 | −3.2886E−02 | −4.7884E−02 | −2.6848E−02 | 1.4211E−02 | −7.3659E−02 |
| A6 = | −6.2094E−03 | 1.0465E−01 | 6.3203E−02 | −7.9173E−03 | −4.4109E−02 | 4.7860E−02 |
| A8 = | 3.8345E−03 | −1.4585E−01 | −1.0332E−02 | 1.1077E−01 | 7.6527E−02 | 4.7931E−02 |
| A10 = | −6.3266E−02 | 1.9972E−02 | −1.0813E−01 | −2.3653E−01 | 7.5126E−03 | −1.9401E−02 |
| A12 = | 9.4009E−02 | 4.3283E−02 | 5.1147E−02 | 1.4616E−01 | 2.0244E−03 | 3.2500E−03 |
| A14 = | −5.8433E−02 | −2.8830E−02 | 1.1229E−02 | −1.2848E−02 | — | — |
| | Surface # | | | | | |
| | 8 | 9 | 10 | 11 | 12 | 13 |
| k = | −4.7161E+00 | −6.6469E+00 | −7.9572E+00 | −5.9912E−01 | −6.1347E+00 | −6.5357E+00 |
| A4 = | −1.3628E−01 | −5.1368E−02 | 1.9576E−02 | 8.8923E−02 | −1.9757E−01 | −1.1121E−01 |
| A6 = | −7.4680E−03 | −4.2785E−02 | −2.6742E−02 | −4.7282E−02 | 9.4988E−02 | 3.6453E−02 |
| A8 = | 6.4602E−03 | 5.0975E−03 | 8.5962E−02 | 3.1665E−02 | −6.4935E−02 | −1.4221E−02 |
| A10 = | −6.5700E−02 | 8.7719E−03 | −4.8001E−02 | 1.0429E−02 | 3.8628E−02 | 4.4849E−03 |
| A12 = | 1.9689E−02 | −6.0531E−03 | 7.1044E−03 | −4.8899E−03 | −1.2251E−02 | −9.0047E−04 |
| A14 = | 6.3824E−02 | 1.7198E−03 | 3.3272E−03 | −3.9490E−03 | 1.8969E−03 | 1.0066E−04 |
| A16 = | −6.7805E−02 | — | −2.5200E−03 | 1.3597E−03 | −1.1476E−04 | −5.0811E−06 |

TABLE 11
Optical Data of the Wide-Angle Lens Assembly according to the 2nd Embodiment
f(W) = 1.67 mm, Fno(W) = 2.07, HFOV(W) = 46.6 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Lens 1 | 5.667 | (ASP) | 0.304 | Plastic | 1.544 | 55.9 | −38.76 |
| 2 | | 4.383 | (ASP) | 0.354 | | | | |
| 3 | Ape. Stop | Plano | | 0.050 | | | | |
| 4 | Lens 2 | 12.740 | (ASP) | 0.392 | Plastic | 1.544 | 55.9 | 3.69 |
| 5 | | −2.356 | (ASP) | 0.030 | | | | |
| 6 | Lens 3 | 2.518 | (ASP) | 0.230 | Plastic | 1.639 | 23.5 | −9.44 |
| 7 | | 1.713 | (ASP) | 0.124 | | | | |
| 8 | Lens 4 | −4.041 | (ASP) | 0.732 | Plastic | 1.544 | 55.9 | 1.13 |
| 9 | | −0.566 | (ASP) | 0.030 | | | | |
| 10 | Lens 5 | 0.914 | (ASP) | 0.270 | Plastic | 1.639 | 23.5 | −1.75 |
| 11 | | 0.445 | (ASP) | 0.500 | | | | |

| | | | | | | | |
|---|---|---|---|---|---|---|---|
| 12 | IR-cut filter | Plano | 0.210 | Glass | 1.517 | 64.2 | — |
| 13 | | Plano | 0.394 | | | | |
| 14 | Image | Plano | — | | | | |

Note:
Reference wavelength is 587.6 nm (d-line).

TABLE 12
Aspheric Coefficients of the Wide-Angle Lens
Assembly according to the 2nd Embodiment

| Surface # | 1 | 2 | 4 | 5 | 6 |
|---|---|---|---|---|---|
| k = | −1.5073E+01 | 1.1637E+01 | 3.0998E+01 | 1.0330E+01 | −3.5762E+00 |
| A4 = | 4.7630E−01 | 9.5819E−01 | −1.0157E−01 | −1.0781E+00 | −1.0518E+00 |
| A6 = | −4.3915E−01 | −2.6275E+00 | −3.1480E+00 | 1.5465E+00 | −1.6845E+00 |
| A8 = | 6.8975E−01 | 9.9575E+00 | 3.6055E+01 | 3.5003E+00 | 2.4828E+01 |
| A10 = | −2.6464E−01 | −1.5109E+01 | −2.3885E+02 | −2.8964E+01 | −1.0018E+02 |
| A12 = | 1.7794E−02 | 6.5130E+00 | 4.4466E+02 | 2.6452E+01 | 1.9271E+02 |
| A14 = | — | — | — | — | −1.3934E+02 |
| Surface # | 7 | 8 | 9 | 10 | 11 |
| k = | −3.5817E+00 | 3.2665E−01 | −1.7372E+00 | −4.1140E+00 | −3.6431E+00 |
| A4 = | 2.2954E−01 | 8.5629E−01 | 6.2278E−01 | −7.2931E−01 | −4.6825E−01 |
| A6 = | −4.3746E+00 | −3.0347E+00 | −4.2714E+00 | 7.8097E−01 | 2.8856E−01 |
| A8 = | 1.9882E+01 | 7.4471E+00 | 1.5599E+01 | −1.8398E+00 | −2.5760E−02 |
| A10 = | −4.7261E+01 | −5.8438E+00 | −3.6966E+01 | 3.5116E+00 | −1.4120E−01 |
| A12 = | 5.7542E+01 | −1.1151E+01 | 5.4407E+01 | −3.6643E+00 | 1.2941E−01 |
| A14 = | −2.7582E+01 | 2.5712E+01 | −4.1409E+01 | 1.9355E+00 | −5.1642E−02 |
| A16 = | — | −1.4728E+01 | 1.2219E+01 | −4.0380E−01 | 8.0737E−03 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 7 through Table 12 as the following values and satisfy the following conditions:

2nd Embodiment

| | | | |
|---|---|---|---|
| FOV(T) [deg.] | 29.0 | D(W) [mm] | 29.0 |
| FOV(M) [deg.] | 64.2 | FOV(W)/FOV(T) | 3.21 |
| FOV(W) [deg.] | 93.2 | FNO(T) | 2.45 |
| TL(T) [mm] | 4.18 | FNO(M) | 2.20 |
| TL(M) [mm] | 5.07 | FNO(W) | 2.07 |
| TL(W) [mm] | 3.62 | f(T)/f(W) | 2.77 |
| BL(T) [mm] | 0.79 | FOV(M) − FOV(T) [deg.] | 35.2 |
| BL(M) [mm] | 1.43 | FOV(W) − FOV(M) [deg.] | 29.0 |
| BL(W) [mm] | 1.10 | Pixel(T) [um] | 1.12 |
| D(T) [mm] | 3.58 | Pixel(M) [um] | 1.10 |
| D(M) [mm] | 5.60 | Pixel(W) [um] | 1.12 |

The foregoing image capturing unit is able to be installed in, but not limited to, an electronic device, including smart phones, tablet personal computers and wearable apparatus. According to the present disclosure, the camera unit includes the wide-angle lens assembly, the standard lens assembly and the telephoto lens assembly with different field of views. The wide-angle lens assembly, the standard lens assembly and the telephoto lens assembly are all single focus lens assemblies so that it is unnecessary to dispose additional add-on components, thereby it is favorable for keeping the camera unit compact. When specific conditions are satisfied, the wide-angle lens assembly, the standard lens assembly and the telephoto lens assembly with different field of views are favorable for capturing a plurality of images having various magnifications so as to satisfy the requirement of the ability of optical zoom. Furthermore, it is also favorable for providing high zoom ratios and large zoom range so as to improve the ability of optical zoom of the camera unit.

The foregoing description, for the purpose of explanation, has been described with reference to specific embodiments. It is to be noted that TABLES 1-12 show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A camera unit, comprising:
a wide-angle image capturing module, comprising:
a wide-angle lens assembly, in order from an object side to an image side, comprising a first lens element thereof closest to the object-side and a last lens element thereof closest to the image-side, and both of the first lens element and the last lens element of the wide-angle lens assembly having refractive power; and
a wide-angle image sensor disposed on the image-side of the wide-angle lens assembly;
a standard image capturing module, comprising:
a standard lens assembly, in order from an object side to an image side, comprising a first lens element thereof closest to the object-side and a last lens element thereof closest to the image-side, and both of the first lens element and the last lens element of the standard lens assembly having refractive power; and
a standard image sensor disposed on the image-side of the standard lens assembly; and
a telephoto image capturing module, comprising:
a telephoto lens assembly, in order from an object side to an image side, comprising a first lens element thereof closest to the object-side and a last lens element thereof closest to the image-side, and both of the first lens element and the last lens element of the telephoto lens assembly having refractive power; and
a telephoto image sensor disposed on the image-side of the telephoto lens assembly;
wherein each of the lens elements of the wide-angle lens assembly, the standard lens assembly and the telephoto lens assembly with refractive power has an object-side surface and an image-side surface, the wide-angle lens assembly, the standard lens assembly and the telephoto lens assembly are all single focus lens assemblies, a maximal field of view of the wide-angle lens assembly is FOV(W), a maximal field of view of the standard lens assembly is FOV(M), a maximal field of view of the telephoto lens assembly is FOV(T), and the following conditions are satisfied:
FOV(T)<FOV(M)<FOV(W);
15 degrees (deg.)<FOV(T)<50 deg.;
45 deg.<FOV(M)<100 deg.; and
70 deg.<FOV(W)<150 deg.

2. The camera unit of claim 1, wherein the maximal field of view of the wide-angle lens assembly is FOV(W), the maximal field of view of the standard lens assembly is FOV(M), the maximal field of view of the telephoto lens assembly is FOV(T), and the following conditions are satisfied:
30 deg.<FOV(T)<45 deg.;
70 deg.<FOV(M)<95 deg.; and
110 deg.<FOV(W)<140 deg.

3. The camera unit of claim 1, wherein the maximal field of view of the wide-angle lens assembly is FOV(W), the maximal field of view of the standard lens assembly is FOV(M), the maximal field of view of the telephoto lens assembly is FOV(T), and the following conditions are satisfied:
20 deg.<FOV(T)<40 deg.;
45 deg.<FOV(M)<70 deg.; and
75 deg.<FOV(W)<100 deg.

4. The camera unit of claim 1, wherein an axial distance between the object-side surface of the first lens element of the wide-angle lens assembly and the wide-angle image sensor is TL(W), an axial distance between the object-side surface of the first lens element of the standard lens assembly and the standard image sensor is TL(M), an axial distance between the object-side surface of the first lens element of the telephoto lens assembly and the telephoto image sensor is TL(T), and the following conditions are satisfied:
TL(W)<10 millimeters (mm);
TL(M)<10 mm; and
TL(T)<10 mm.

5. The camera unit of claim 1, wherein an axial distance between an image-side surface of the last lens element of the wide-angle lens assembly and the wide-angle image sensor is BL(W), an axial distance between an image-side surface of the last lens element of the standard lens assembly and the standard image sensor is BL(M), an axial distance between an image-side surface of the last lens element of the telephoto lens assembly and the telephoto image sensor is BL(T), and the following conditions are satisfied:
BL(W)<2 mm;
BL(M)<2 mm; and
BL(T)<2 mm.

6. The camera unit of claim 1, wherein each of the wide-angle lens assembly, the standard lens assembly and the telephoto lens assembly further comprises an independent lens barrel.

7. The camera unit of claim 1, wherein a diagonal length of an effective photosensitive area of the wide-angle image sensor is D(W), a diagonal length of an effective photosensitive area of the standard image sensor is D(M), a diagonal length of an effective photosensitive area of the telephoto image sensor is D(T), and the following conditions are satisfied:
D(T)<D(M); and
D(W)<D(M).

8. The camera unit of claim 1, wherein at least one of the wide-angle image capturing module, the standard image capturing module and the telephoto image capturing module further comprises an auto-focusing lens actuator.

9. The camera unit of claim 1, wherein at least one of the wide-angle image capturing module, the standard image capturing module and the telephoto image capturing module further comprises an optical image stabilization unit.

10. The camera unit of claim 4, wherein the axial distance between the object-side surface of the first lens element of the wide-angle lens assembly and the wide-angle image sensor is TL(W), the axial distance between the object-side surface of the first lens element of the standard lens assembly and the standard image sensor is TL(M), the axial distance between the object-side surface of the first lens element of the telephoto lens assembly and the telephoto image sensor is TL(T), and the following conditions are satisfied:
TL(W)<8 mm;
TL(M)<8 mm; and
TL(T)<8 mm.

11. The camera unit of claim 1, wherein the maximal field of view of the wide-angle lens assembly is FOV(W), the maximal field of view of the telephoto lens assembly is FOV(T), and the following condition is satisfied:
2.0<FOV(W)/FOV(T)<5.0.

12. The camera unit of claim 1, wherein an f-number of the wide-angle lens assembly is Fno(W), an f-number of the standard lens assembly is Fno(M), an f-number of the telephoto lens assembly is Fno(T), and the following conditions are satisfied:
1.5<Fno(W)<3.0;
1.5<Fno(M)<3.0; and
1.5<Fno(T)<3.0.

13. The camera unit of claim 1, wherein an f-number of the standard lens assembly is Fno(M), and the following condition is satisfied:
1.5<Fno(M)<2.4.

14. The camera unit of claim 1, wherein all lens elements of the wide-angle lens assembly, the standard lens assembly and the telephoto lens assembly with refractive power are made of plastic material, and at least one of the image-side surfaces of the last lens elements of the wide-angle lens assembly, the standard lens assembly, and the telephoto lens assembly has a wave-like shape.

15. The camera unit of claim 1, wherein a focal length of the wide-angle lens assembly is f(W), a focal length of the telephoto lens assembly is f(T), and the following condition is satisfied:
2.0<f(T)/f(W)<5.0.

16. The camera unit of claim 1, wherein there are at least three and fewer than seven lens elements with refractive power in each of the wide-angle lens assembly, the standard lens assembly and the telephoto lens assembly.

17. The camera unit of claim 16, wherein there are at least four and fewer than six lens elements with refractive power in each of the wide-angle lens assembly, the standard lens assembly and the telephoto lens assembly.

18. The camera unit of claim 1, wherein the maximal field of view of the wide-angle lens assembly is FOV(W), the maximal field of view of the standard lens assembly is FOV(M), the maximal field of view of the telephoto lens assembly is FOV(T), and the following conditions are satisfied:
15 deg.<FOV(M)−FOV(T)<45 deg.; and
20 deg.<FOV(W)−FOV(M)<60 deg.

19. The camera unit of claim 5, wherein the axial distance between the image-side surface of the last lens element of the wide-angle lens assembly and the wide-angle image sensor is BL(W), the axial distance between the image-side surface of the last lens element of the standard lens assembly and the standard image sensor is BL(M), the axial distance between the image-side surface of the last lens element of the telephoto lens assembly and the telephoto image sensor is BL(T), and the following conditions are satisfied:
BL(W)<1.5 mm;
BL(M)<1.5 mm; and
BL(T)<1.5 mm.

20. The camera unit of claim 1, wherein each of the wide-angle image sensor, the standard image sensor and the telephoto image sensor has a pixel size smaller than 2.0 micrometers (μm).

21. The camera unit of claim 1, wherein the wide-angle image capturing module, the standard image capturing module and the telephoto image capturing module are disposed in a linear or triangular arrangement.

22. The camera unit of claim 1, wherein the maximal field of view of the wide-angle lens assembly is FOV(W), and the following condition is satisfied:
110 deg.<FOV(W)<140 deg.

23. The camera unit of claim 1, wherein the maximal field of view of the telephoto lens assembly is FOV(T), and the following condition is satisfied:
20 deg.<FOV(T)<40 deg.

24. The camera unit of claim 1, wherein an axial distance between an object-side surface of the first lens element of the wide-angle lens assembly and the wide-angle image sensor is TL(W), an axial distance between an object-side surface of the first lens element of the telephoto lens assembly and the telephoto image sensor is TL(T), and the following condition is satisfied:
TL(W)<TL(T).

25. An electronic device, comprising:
the camera unit of claim 1;
wherein a plurality of raw images are captured from at least two of the wide-angle image capturing module, the standard image capturing module and the telephoto image capturing module of the camera unit, and a final photographed image is produced by post-processing of the raw images.
